(19) United States
(12) Patent Application Publication
(10) Pub. No.: US 2010/0139709 A1
(43) Pub. Date: Jun. 10, 2010

(54) Method for Cleaning Beverage Filling Lines

(76) Inventors: Michael Saefkow, Weinsberg (DE); André Philipps, Regensburg (DE); Manuel Czech, Donaustauf (DE)

Correspondence Address: FOLEY & LARDNER LLP, 111 HUNTINGTON AVENUE, 26TH FLOOR, BOSTON, MA, 02199-7610, US

(21) Appl. No.: 12/448,768

(22) PCT Filed: Jan. 8, 2008
(86) PCT No.: PCT/EP2008/000099

§ 371 Date: Feb. 23, 2010

(30) Foreign Application Priority Data
Jan. 8, 2007 (DE) 10 2007 001 294.4
Apr. 13, 2007 (DE) 10 2007 017 523.1

(51) Int. Cl. B08B 9/027

(52) U.S. Cl. 134/32

(57) ABSTRACT

In a process for cleaning beverage filling plants, one or more beverage filling devices (30) including a filling head (32) inside a beverage filling chamber (20) of the beverage filling line (20) are rinsed during the operation of the beverage filling line continuously or intermittently with an aqueous, hygienically non-hazardous cleaning agent (110), present at ambient temperature. Preferably, in addition, vessels (48) which, in the beverage filling chamber (40a) are filled with a beverage (35) and/or a conveyer device (6) for conveying the vessels to the beverage filling chamber (20), are rinsed continuously or intermittently with the cleaning agent (110). The cleaning agent preferably has disinfectant activity.

The present invention relates to a process for cleaning beverage filling lines.

Beverage filling lines are subject to ongoing contamination by the beverage to be filled, for example, because between two filling procedures, beverage continues to drip from the filling head, the vessel runs over or the beverage foams over from the vessel, and similar reasons. The moist contaminated regions of the filling line form an ideal substrate for microorganisms of all kinds. Accordingly, both from the point of view of esthetics and those of hygiene, it is essential to clean those parts of the filling line, which are subject to contamination in order to ensure a hygienically acceptable filling procedure.

Hitherto, the cleaning of such plants was effected by means of so-called “drenching”. For that purpose, the operation of the machine is interrupted, for example, every one to four hours and spraying is performed, by means of nozzles, e.g. broad jet nozzles, for a couple of minutes, e.g. for 5 minutes with hot water, for example at 85° C., applied to all machine parts. The nozzles are so arranged that all important parts of the filling apparatus can be sprayed thereby.

This drenching involves a number of appreciable drawbacks. Firstly, the plant must be stopped in order to conduct the cleaning; this is an economic drawback. Moreover, the very hot water involves a potential hazard for people. Hot water also causes damage to rubber and plastics components of the filling apparatus and the associated conveyer belts. Moreover, the steam released during drenching, impacts the room environment and in cooler regions thereof results in the formation of condensate which enhances the growth of microorganisms.

A desirable disinfection is likewise not guaranteed. The hot water spray is cooled down considerably after it impacts the components and thereby loses its disinfecting effect. It was found in practice, that only 60 to 70% of the microorganisms are exterminated by such drenching. However, the term disinfection can only apply to an extermination rate of log 5, i.e. a disinfection effect at which only one micro organism out of 100 000 survives.

It was an object of the invention to provide an alternative process for the cleaning of beverage filling plants.

This object is attained by the process according to claim 1.

The subsidiary claims reflect preferred working embodiments of the invention.

In accordance with the present invention, the cleaning of the parts of the filling plant contaminated by the product (beverage) and by microorganisms is performed continuously or intermittently (at time intervals) during the operation of the filling line. The nozzles already installed in the plant for drenching purposes may be used in this context. The installation of further nozzles for spraying additional parts of the plant and the vessel, into which the beverage is to be filled, is being filled or has already been filled, may have to be performed additionally when desired or required.

More particularly, according to the invention, the filling heads are sprayed during the entire filling operation, i.e. before filling as such commences, during the filling as such and after filling as such, whilst the filling line is in operation, continuously or intermittently, i.e., in the case of filling plants operated in circulatory fashion, over the entire outer circle of the filling carrousel, where the vessels are filled. One filling head, a plurality of, or preferably all filling heads are rinsed in this manner continuously or intermittently.

The cleaning agent is sprayed at ambient temperature. This is represented by an aqueous hygienically non-hazardous cleaning agent other than natural water.

The term “hygienically non-hazardous” is understood to mean an ingestion of the cleaning agent by a human involves no significant health hazard greater than the ingestion of clean, natural water, i.e. water as extracted from nature (more appropriately after having been cleaned), e.g. tap- or mineral water; preferably the cleaning agent is of drinking water quality.

Because the cleaning agent offers no health hazard, it is possible to also rinse those parts of the vessel which are close to the mouth of the vessel with the cleaning agent, e.g. the neck of bottles in the case of bottles. The same applies to those parts of the filling device which enter into contact with the beverage, for example the filling heads and their gaskets. Preferably, the closing unit as well, is sprayed continuously or intermittently with the cleaning agent. Absolutely no harm is done if traces of the above defined cleaning agent enter into the beverages.

The cleaning, i.e. each of the herein described cleaning procedures may be performed continuously or intermittently at suitable time intervals. Intermittent cleaning is advantageous whenever water is to be saved. In that case, the time intervals are determined by the degree of contamination of the plant. Thus, the cleaning may, e.g. be performed synchronously every 3, 5, 7, 10 minutes for 30 seconds, 1 minute, 2 minutes at a time.

The beverage filling plant and apparatus may be of any optional type. In general, a beverage filling plant includes at least one beverage filling device having a filling head, a conveyer device for bottles which are generally conveyed in a circulatory fashion, and an apparatus for closing (closing unit) the filled vessels (e.g. by means of crown stoppers, screw stoppers, the bottom of a can, or the like) which, viewed in the conveyance direction, follow onto the beverage filling device. It stands to reason that the beverage filling line may include additional modules which may include fully automatic feed means for the empty vessels as well as the fully automatic packaging of the filled vessels, e.g. in boxes, cartons etc.

Belt conveyers, chain conveyers, link chains or similar modules may in this context serve as the conveyer device.

The vessels for the beverages are generally represented by bottles, cans or even small barrels (e.g. for wine or beer).

The conveyer device is preferably rinsed intensely with the cleaning agent within the filling chamber. In that case it is preferred to subject it to further rinsing after having left the filling chamber. Otherwise, it is to be rinsed in any event after leaving the filling chamber. The same applies to the vessels.

After leaving the filling chamber, liquid residues or contaminated regions, which may contain product, are (still) present on the upper side of the conveyer device. In addition, it is possible that, while the vessels are still open, further product may spill therefrom due to the movement of the vessels caused by the belt or by collisions of vessels on the belt. Since the conveyer device is usually a link chain having open interstitial spaces, these liquid residues may drip onto the part of the conveyer device, situated underneath, returning back to the filling apparatus (if the conveyer device circulates). The conveyer device is preferably to be cleaned not only on its upper side but also on its underside as well as on the upper and underside of the returning part therebelow of the conveyer device between the filling chamber and the device for closing the vessels.

It stands to reason that it is also possible to provide conveyer belts having a closed surface, serving as the conveyer device. In that case, in general, only the upper side of the belt moving towards the device for closing the vessels, need to be cleaned.

It is even more preferred that the conveyer device, if circulated, is cleaned again in the same manner before returning into the filling chamber in order to remove whatever contaminations may have re-occurred.

The vessels as well are preferably rinsed with the cleaning agent whilst in the filling chamber. Thereafter, they are preferably again rinsed from the upper region downwards (e.g. at the bottle neck and therebelow) between the filling chamber and the device for closing the vessels, in order to remove any beverage residues from the vessel exterior, which, in many cases, are sticky, but also may become hotspots for noxious microorganisms, which may then possibly be ingested by a consumer. If the vessels are not rinsed in the filling chamber, this is done in any event after their emersion from the chamber.

The cleaning agent is preferably sprayed from nozzles onto the objects to be cleaned. Depending on requirements, these nozzles may, for example, be represented by broad jet nozzles, flat jet nozzles, high intensity nozzles, etc. In the case of filling plants which are already in use, broad jet nozzles which, previously had been employed for drenching, are frequently already present for cleaning the filling device. These can be used in the process according to the invention. Additional nozzles may be employed for the cleaning of the vessels and the conveyer device.

For cleaning the conveyer device, it is preferred to employ in the upwards-directed regions of the belt (that is to say the upper regions of the conveyer device leading away from the filling device as well as the lower region of the conveyer device returning in the direction of the filling device) flat jet nozzles which are directed inclined to the surface in order to rinse the contaminations through the empty spaces between chain links, from there to drip downwardly. In this context, the lowermost flat jet nozzle should (in relation to the lower belt section) be arranged downstream of the upper flat jet nozzle, so that the liquid residues which drip from the last mentioned nozzle onto the lower belt section, can be removed by the first mentioned nozzle.

The nozzles which link the undersides of the conveyer device may be, but need not be set at an incline.

The cleaning agent is automatically apportioned to the nozzles at the required rate. The expression “at the required rate” is to denote, that, e.g. in regions of reduced contamination, the cleaning agent may be sprayed onto the contaminated regions at a lesser pressure. It was found that the consumption of cleaning agent, when apportioned at a required rate, is less than the water consumption in the case of cleaning by drenching.

The cleaning agent is preferably produced by the admixture of a cleaning concentrate into tap water. Such concentrates, if stored in a closed, light protected vessel, may be stored for prolonged periods.

As a rule, the cleaning agent is a disinfecting cleaning agent. It was mentioned already further above that the term “disinfecting” is to imply that the extent of extermination of microorganisms amounts to at least log 5, i.e. that after the application of the disinfectant (disinfecting cleaning agent) for every 100 000 microorganisms present, at the most one remains.

A disinfecting cleaning medium may e.g. contain one or more molecules/ions/radicals, which are selected from ClO^{.}; ClO⁻; HClO; OH^{.}; HO₂⁻; H₂O₂; O₃; S₂O₈²⁻; Cl₂; Cl^{.}; HO₂^{.}; O₂; O₂^{.}; 30₂; 10₂; O^{.}; H₃O; H^{.}; Cl₂O; ClO₂; HCl; Cl₂O₇; H₂SO₄; and HSO₃Cl. The pH may be 2 to 8, preferably 7, and the redox potential can amount to +300 mV up to +1200 mV.

In the event of a conveyer device contaminated with grease or oil, rinsing with a basic cleaning agent may advantageously be performed upstream of the rinsing with the aforesaid cleaning agent in order to increase the wettability of the conveyer device or for combating thermophilic spores. Such basic cleaning agent may, e.g. have a pH of 7 to 13, a redox potential of −200 mV up to −1100 mV, preferably −800 mV, and contain one or more molecules, ions/radicals selected from OH⁻; H₃⁻; O₂; H₂; HO₂; HO₂⁻ and O₂⁻.

Preferably, the cleaning agent is represented by the cleaning concentrate commercially available under the trade name NADES (concentrate) (aquagroup GmbH, Regensburg, Germany). NADES (concentrate) contains about 99.98% water and about 0.02% (200 ppm) oxidizing agent, more particularly sodium hypochlorite (<197.5 ppm) and chlorine dioxide (<2.5 ppm) at a pH of approximately 7.0.

NADES (concentrate) may in exceptional cases be employed at up to 100%, i.e. in the extreme case, as such in the process according to the invention but more frequently at up to 50% of the cleaning agent, the remainder being water; however, in general it is added to water (ordinary tap water) in amounts of 0.1 to 10% in order to obtain the cleaning agent used according to the invention.

It should also be mentioned that, in the event of a conveyer device contaminated with grease or oil, in order to increase its wettability or for combating thermophylic spores, rinsing may be advantageously performed upstream of rinsing with NADES base (concentrate), optionally diluted with water.

NADES base (concentrate), besides water, contains 880 ppm (0.088%) NaOH as total alkalinity and may, besides other reducing species contain nitrite (14.79 ppm), chloride (11.70 ppm) phosphate (11.48 ppm), sulphate (7.89 ppm), nitrate (1.14 ppm), sodium (439.00) ppm and potassium (3.60 ppm). Because of the low content of NaOH (0.088%) no hazard can be caused by NADES base to humans, animals or the environment. Accordingly, NADES base is unaffected by regulations for hazardous substances.

NADES base (concentrate) may be employed in concentrations up to 100%, but is in general added for cleaning purposes to ordinary water in amounts of 0.1 to 50%.

In special cases, NADES base and NADES may also be employed as a mixture.

Rinsing with a neutral cleaning agent, e.g. NADES (concentrate) optionally diluted with water, downstream of rinsing with a cleaning agent containing NADES base is to be recommended.

As regards the beverages which may be filled in the beverage filling plant, these may be represented by any optional beverage. Beer is a particularly preferred beverage, since, when it is filled, because of foaming thereof, a particularly heavy contamination of the plant is generally experienced. Other beverages which may be filled using the process according to the invention, are for example mineral water, juice, wine, spirits, other alcoholic beverages (e.g. alcopops), non-alcoholic mixed beverages (which include the so-called “energy drinks”) and milk.

### BRIEF DESCRIPTION OF THE FIGURES

FIG. 1 represent a diagrammatic side elevation of a beverage filling plant with a transparent beverage filling chamber, in which a beverage filling device is accommodated, a conveyer device and a symbolized closure station for beverage vessels as well as a variety of nozzles for spraying the cleaning agent.

FIG. 2 represents a perspective view of the turn-around region of a conveyer belt composed of chain links including nozzles for the spraying of cleaning agent.

The process according to the invention will now be described in more detail by way of a working example.

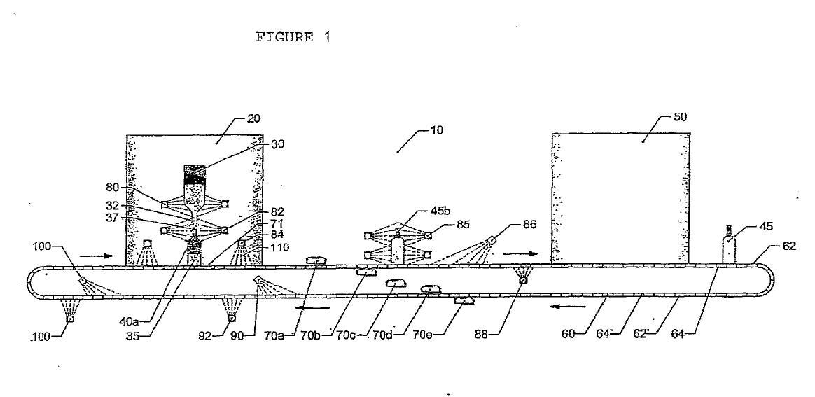

In FIG. 1, a beverage filling plant 10 is shown diagrammatically. In a beverage filling chamber 20, which frequently is transparent, a beverage filling device 30 is accommodated, by means of which by way of a filling head 32, a beverage 35 is filled into bottles 40a (or another kind of vessel). In the course thereof, beverage 35 or foam 37 may spill from the bottle (40a) causing contamination 71 of a conveyer belt 60. Subsequent dripping of beverage from the filling head 32 may also contaminate the belt during the onward conveyance of a filled bottle 40b from the filling head 32 and while an empty bottle (not shown) is forwarded below the filling head 32.

During the filling procedure, cleaning agent 110 is sprayed continuously onto the filling apparatus 30 and its filling head 32 as well as onto the bottles 40a and the conveyer belt 60 by way of nozzles 80, 82, 84 which may be broad jet nozzles. Liquid residues 70a of the cleaning agent mixed with beverage remain on the surface 62 of the conveyer belt 60 moving in the direction of the uppermost arrow.

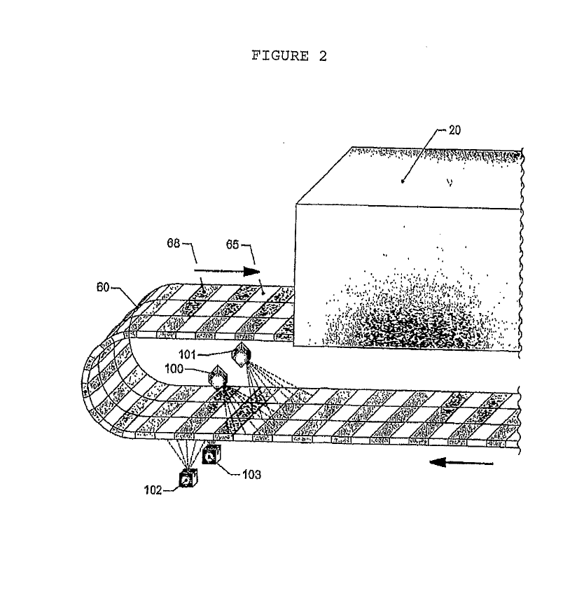

Since the belt 60 is normally assembled from chain links 68 providing empty interstices 65, as shown in FIG. 2, the liquid residues 70b can get onto the underside 64 of the conveyer belt 60, from where they drip downwards 70c and may impinge 70d onto the opposite side 64′ of the reversed belt 60 which now moves in the direction of the lowermost arrow (that is to say the previous underside 64). From there they may proceed further onto the outside 62′ of the reversed belt (what previously was the upper side 62) and drip onto the floor (not shown).

The filled, but not yet closed bottles 40 b are conveyed on the conveyer belt likewise in the direction of the upper belt, to a closing station 50. In the closing station 50 the bottles are closed (not shown) with corks, crown stoppers or the like. The closed bottles 45 are then removed from the belt and packed (not shown) in boxes or cartons. On their way to the closing station 50, shaking of the bottle 40b by the belt or by collisions of the bottles 40b may cause further beverage or further foam (not shown) to spill from the bottle.

For that reason, the belt 60, on its way to the closing station 50 or on its opposite side away from there, may be further sprayed with cleaning agent 110 from nozzles 86, 88, 90, 92. The nozzles 86, 90 and 100, which are aimed onto the upper sides 64 and 64′ of the conveyer belt, are preferably a flat jet nozzle, being directed at an incline in opposition to the direction of movement of the belt. A jet of cleaning agent 110 emerging from such a nozzle 86, 80, 100 impinges at an incline onto the chain links 68 of the belt such that the liquid residues 70a are rinsed through the interstices 65 between the links 68 (see FIG. 2) and drip downwardly. In this context, the nozzle 90 which sprays onto the upper side 64′ of the reversed belt returning to the filling chamber, should be positioned, viewed in the direction of conveyance, downways of the nozzle 68, spraying onto the upper side 64 as well as downways of the nozzle 88 spraying onto the underside 62′ in order to rinse away the liquid residues 70d dripping from above. The underside 64 and the exterior 62′ of the conveyer belt may, for example, be rinsed with broad jet nozzles 88, 92. Instead of the individual nozzles 86, 88, 90, 92 as shown, it is also possible for a plurality of single nozzles arranged transversely to the conveyance direction to be provided side by side which, jointly, span the width of the belt.

Prior to the re-entry of the belt returning into the filling chamber, the former is rinsed again, for example prior to the reversal locality, by means of nozzles 200, 101 and 102, 103 (see FIG. 2). The nozzles 100, 101 and 102, 103 are in each case located transversely to the conveyance direction and parallel to the chain links 68. The nozzles 100, 102 are again shown as flat jet nozzles, aimed inclined to the conveyance direction, whereas the nozzles 102, 103 are shown as broad jet nozzles.

1. Process for cleaning beverage filling lines, in which one or more beverage filling devices (30) including a filling head (32) inside a beverage filling chamber (20) of the beverage filling line, during the operation of the beverage filling line are continuously or intermittently rinsed with an aqueous, hygienically non-hazardous cleaning agent (110), present at an ambient temperature and differing from natural water.

2. Process according to claim 1, characterized in that also vessels (40a), which in the beverage filling chamber (2) are filled with a beverage (35) are rinsed continuously or intermittently during the operation of the beverage filling line, inside the vessel filling chamber (2) with the cleaning agent (110).

3. Process according to claim 1 or 2, characterized in that also a conveyer device (60) for the conveyance of the vessels (40a) during its movement through the beverage filling chamber (20) is rinsed continuously or intermittently with cleaning agent (110).

4. Process according to one of claims 1 to 3, characterized in that the vessels (40a) are represented by bottles, cans or small barrels.

5. Process according to one of claims 1 to 4, characterized in that the conveyer device (60) and the conveyed, filled, non-closed vessels (40b), after leaving the filling chamber (20), are rinsed continuously or intermittently with the cleaning agent (110) during the operation of the beverage filling line, the rinsing being optionally a further rinsing.

6. Process according to one of claims 1 to 5, characterized in that the conveyer device (60) is circulated and prior to its re-entry into the filling chamber (20), is again rinsed continuously or intermittently during the operation of the beverage filling line.

7. Process according to one of claims 1 to 6, characterized in that the cleaning agent (110) is sprayed from nozzles (82, 84, 85 86, 88, 90, 92, 100, 101, 102, 103) onto the objects (30, 32, 40a, 40b, 60) to be cleaned, mentioned in one of claims 1 to 4.

8. Process according to one of claims 1 to 7, characterized in that the cleaning agent (110) is apportioned into the nozzles (82, 84, 85, 86, 88, 90, 92, 100, 101, 102, 103) as needed.

9. Process according to one of claims 1 to 8, characterized in that the cleaning agent (110) contains a mixture of tap water and a cleaning concentrate.

10. Process according to one of claims 1 to 9, characterized in that the cleaning agent is represented by a disinfecting agent.

11. Process according to one of claims 1 to 10, characterized in that the cleaning agent contains one or more molecules/ions/radicals selected from ClO^{.}; ClO⁻; HClO; OH^{.}; HO₂⁻; H₂O₂; O₃; S₂O₈^{2 -}; Cl₂; Cl; HO₂^{.}; O₂; O₂^{.}; 30₂; 10₂; O^{.}; H₃O; H^{.}; Cl₂O ; ClO₂; HCl; Cl₂O₇; H₂SO₄; and HSO₃ and the pH amounts to 2 to 8, preferably 7, and the redox potential amounts to +300 mV up to +1200 mV.

12. Process according to one of claims 1 to 10, characterized in that the cleaning agent used is NADES (concentrate).

13. Process according to one of claims 1 to 11, characterized in that the beverage (35) is beer. Process according to one of claims 1 to 11, characterized in that the beverage (35) is mineral water, juice, wine, spirits, other alcoholic beverages, non-alcoholic mixed beverages or milk.
